(19) United States
(12) Patent Application Publication
(10) Pub. No.: US 2018/0263236 A1
(43) Pub. Date: Sep. 20, 2018

(54) Rodent Trap Assembly

(71) Applicant: John McNeill, Victoria, TX (US)

(72) Inventor: John McNeill, Victoria, TX (US)

(21) Appl. No.: 15/463,282

(22) Filed: Mar. 20, 2017

(51) Int. Cl. A01M 23/18; A01M 25/00; A01M 31/00

(52) U.S. Cl. CPC A01M 23/18; A01M 31/008; A01M 25/002

(57) ABSTRACT

A rodent trap includes a housing, a central separation mount, a top plate, first and second door members, and first and second trip levers. The central separation mount separates the housing into first and second traps. The first and second door members are attached to the housing to allow closure and opening of first and second entrances. When a rodent enters the rodent trap, the weight of the rodent on a first food tray causes the first trip lever to engage with the first door member such that the first door member closes the first entrance, thereby trapping the rodent inside the first trap. Similarly, the weight of the rodent on a second food tray causes the second trip lever to engage with the second door member such that the second door member closes the second entrance, thereby trapping the rodent inside the second trap.

### BACKGROUND

### Field of the Invention

The present invention relates generally to animal traps. More particularly, the present invention relates to a rodent trap for trapping and disposing rodents such as rats and mice.

### Description of the Related Art

Rodents such as mice and rats are a significant nuisance and source of danger, and can invade a home or a commercial establishment to seek food, water, and warmth. In farming, harvesting, and storing of food grains, rodents cause a heavy and irreplaceable loss by damaging and contaminating the food grains. Further, rodents damage and contaminate food stored not only in silos and but also in local buildings such as bakeries and restaurants causing significant financial loss to such businesses. They contaminate food by eating, urinating and depositing feces on food. More than often, they cause electrical fires by chewing electrical wires. Further, rodents act as vectors, for a variety of diseases such as Leptospirosis, by carrying fleas, lice, and ticks. Also, rodents proliferate in large numbers rapidly. Thus, there is a dire need to get rid of the rodents.

Rodents are generally controlled through the use of poison or traps. The more common of these is the use of chemical pesticides as the poison. However, chemical pesticides are not usually effective to efficiently eliminate and dispose of large number of rodents. Further, the pesticides contaminate soil, atmosphere, and other elements of the environment. Moreover, such pesticides adversely affect the health of pets and humans who are, or may be, exposed to them.

Another method to control the menace of rodents is to trap in the rodent traps. There are typically two types of rodent traps. A first type of rodent trap kills and mutilates the trapped rodent. An example of the first type of rodent trap is a spring-loaded snap trap. These rodent traps are inexpensive. However, they are unsanitary and unsightly after the animal has been trapped, dangerous to pets and children, and difficult to set. A second type of rodent trap traps a rodent alive in an enclosure. The second type of rodent trap, by design, can be either disposable and/or reusable. Generally, the second type of rodent trap is more expensive as compared to the first type of rodent trap. This is because the second type of rodent trap has an excessive number of component parts with expensive mold and assembly costs. Further, rodent traps are generally made of metal to improve the life time of the trap. However, rodent traps made of metal get damaged due to rodent excrement that might cause rusting of the metal.

Many of the traps disclosed describe an entrapment set-up to lure the rodent into the trap, and its weight or the eating of bait triggers a closing mechanism to effectively lock the rodent inside the trap One such trap is described in U.S. Pat. No. 4,144,667 to Souza having a self-locking disposal rodent trap. The trap is slightly greater than the size of the animal and once it enters, it cannot leave. Another is described in U.S. Pat. No. 6,397,517 to Leyerle et al describing a bait station having an interior mechanical rodent trap.

A rodent trap is disclosed in the U.S. Pat. No. 6,622,422. The patent discloses a repeating animal trap with tilting floor assembly. As the animal crawls in to the repeating animal trap, through an entrance opening along the pathway, the weight of the animal causes the floor to tilt and triggers a door member. When the door member is triggered, it attains a raised position. Once the door member attains the raised position it blocks any attempt by the animal to return to the entrance opening. However, the described repeating animal trap includes a complex structure with multiple components such as multiple flanges and catches. Hence it is expensive to manufacture. Further, the design of the repeating animal trap is such that it is inconvenient for cleaning in case the animal poops in the assembly.

A first type of rodent trap is disclosed in the U.S. Pat. No. 3,975,857. A rodent enters the trap disclosed in the patent and crawls towards a bait. The floor tilts because of the weight of the rodent, and activates a treadle platform. The weight of the rodent on the treadle platform causes a treadle to rotate. This rotation causes a trip lever that supports a door to move such that the door closes. With the door closed an air tight seal chamber is formed. Thus, when the oxygen in the air tight seal chamber is used up the trapped rodent dies. However, this method of killing a rodent appears inhuman. Further, the rodent trap can only be used once and has to be disposed along with the dead rodent. Moreover, the rodent trap includes a complex structure and hence is expensive to manufacture. Further, many a times, the dead rodent is disposed of in an unsanitary manner and leads to decomposing the body, resulting in a spread of foul smell.

In light of the foregoing discussion, there exists a need for a rodent trap that has a simple structure, is durable, is reusable, and allows good sanitary conditions to be maintained.

### SUMMARY

An object of the present invention is to provide a rodent trap (interchangeably called “trap”) that uses few components and has a simple structure.

An object of the present invention is to provide a rodent trap that is reusable and durable.

A rodent trap includes a housing, a central separation mount, a top plate, first and second door members, and first and second trip levers. The housing has a bottom wall, a first side wall, and a second side wall that form first and second entrances. The central separation mount is attached to the housing and separates the housing into first and second traps. The top plate is attached to the central separation mount. Further, the first door member is attached to the housing to allow closure and opening of the first entrance. The first trip lever includes a first arm that is movably attached to the first door member, a first fulcrum mount, and a first food tray for holding bait. When a rodent enters the rodent trap, the weight of the rodent on the first food tray causes the first trip lever to engage with the first door member such that the first door member closes the first entrance, thereby trapping the rodent inside the first trap. The second door member is attached to the housing to allow closure and opening of the second entrance. The second trip lever includes a second arm that is movably attached to the second door member, a second fulcrum mount, and a second food tray for holding bait. When the rodent enters the rodent trap, the weight of the rodent on the second food tray causes the second trip lever to engage with the second door member such that the second door member closes the second entrance, thereby trapping the rodent inside the second trap.

While the description herein is geared towards a double rodent trap, essentially 2 in 1 trap wherein 1 trap will secure 2 rodents, it is understood that it can be built as a single rodent trap. The size can vary as desired by the user and as needed to trap the particular size of rodent.

The trap can be built of plastic (clear, opaque, or colored), metal, or wood. Although wood may be a bit difficult but not impossible.

### BRIEF DESCRIPTION OF DRAWINGS

The features of the present invention, which are believed to be novel, are set forth with particularity in the appended claims. Embodiments of the present invention will hereinafter be described in conjunction with the appended drawings provided to illustrate and not to limit the scope of the claims, wherein like designations denote like elements, and in which:

FIG. 1 shows a schematic sectional view of a rodent trap with first and second entrances closed;

FIG. 2 shows an isometric view of a housing of the rodent trap of FIG. 1;

FIG. 3 shows an isometric view of a central separation mount of the rodent trap of FIG. 1;

FIG. 4 shows an isometric view of a first trip lever of the rodent trap of FIG. 1;

FIG. 5 shows an isometric view of the first trip lever and a second trip lever attached to the central separation mount of the rodent trap of FIG. 1;

FIG. 6 shows an isometric view of a top plate of the rodent trap of FIG. 1;

FIG. 7 shows a front view of a first door member of the rodent trap of FIG. 1; and

FIG. 8 shows a schematic sectional view of the rodent trap of FIG. 1 with the first entrance open and the second entrance closed.

### DETAILED DESCRIPTION OF EMBODIMENTS

As used in the specification and claims, the singular forms “a”, “an” and “the” include plural references unless the context clearly dictates otherwise. For example, the term “an article” may include a plurality of articles unless the context clearly dictates otherwise.

Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention.

There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components which constitutes a rodent trap. Accordingly, the components and the method steps have been represented, showing only specific details that are pertinent for an understanding of the present invention so as not to obscure the disclosure with details that will be readily apparent to those with ordinary skill in the art having the benefit of the description herein.

As required, detailed embodiments of the present invention are disclosed herein;
however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

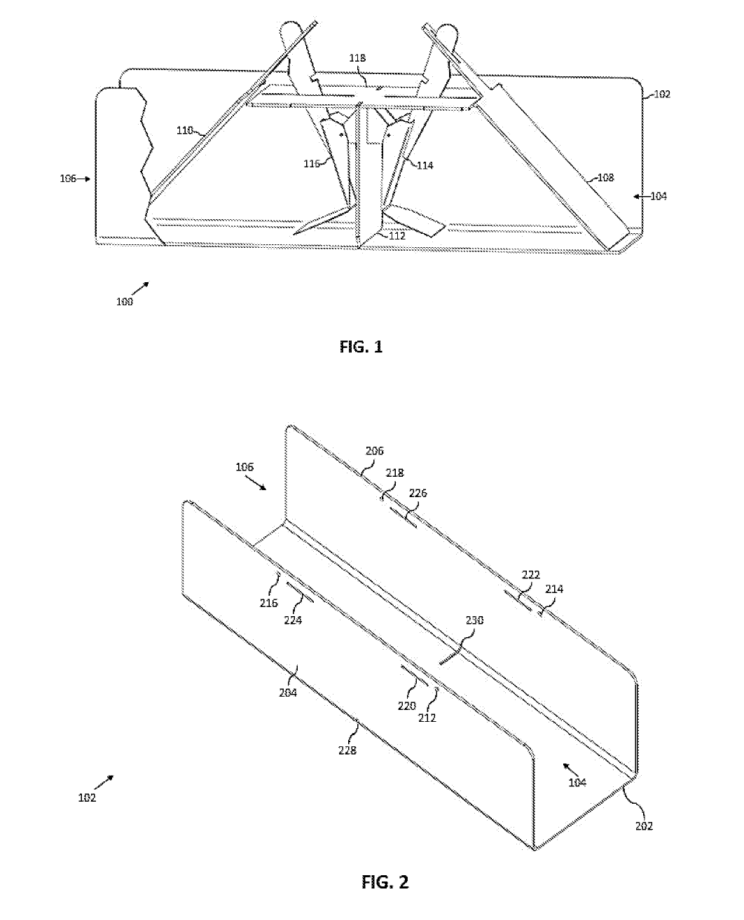

Referring now to FIG. 1 a schematic sectional view of a rodent trap 100 according to an illustrative embodiment of the present invention is shown. The rodent trap 100 includes a housing 102, first and second entrances 104 and 106, first and second door members 108 and 110, a central separation mount 112, first and second trip levers 114 and 116, and a top plate 118. The rodent trap 100 traps rodents such as rats and mice. Other rodents, such as opossum, squirrel and hamster can be trapped within the inventive trap provided the size is appropriate for such rodent. A user of the rodent trap 100 may place bait such as cheese, nuts, and seeds that tempts the rodents to crawl into the rodent trap 100. When the rodent crawls into the rodent trap 100 in lure of the bait, either of the first or second entrances 104 and 106 is closed, thereby trapping the rodent therein. The housing 102, the top plate 118, the central separation mount 112, and the first and second door members 108 and 110 of the rodent trap 100 are made of either plastic (clear, opaque, or colored) or Plexiglas. Other materials such as metal (aluminum, stainless steel, or galvanized steel), glass, or wood may be used, keeping in mind that plastic or Plexiglas is preferred material. It is advantageous to use materials that do not rust and are easy to clean up.

Referring now to FIG. 2 an isometric view of the housing 102 of the rodent trap 100 according to an illustrative embodiment of the present invention is shown. The housing 102 includes a bottom wall 202, a first side wall 204, and a second side wall 206 that form the first and second entrances 104 and 106 formed by the first side wall 204, the second side wall 206, list and the bottom wall 202. The first and second side walls 204 and 206 are perpendicularly mounted on the bottom wall 202 and are opposite to each other. The housing 102 further includes first through fourth holes 212-218 and first through sixth slots 220-230. The first and second holes 212 and 214 are used to attach the first door member 108 to the housing 102. The third and fourth holes 216 and 218 are used to attach the second door member 110 to the housing 102. Further, the first through fourth slots 220-226 are used to attach the top plate 118 to the housing 102. The fifth and sixth slots 228 and 230 are used to attach the central separation mount 112 to the housing 102.

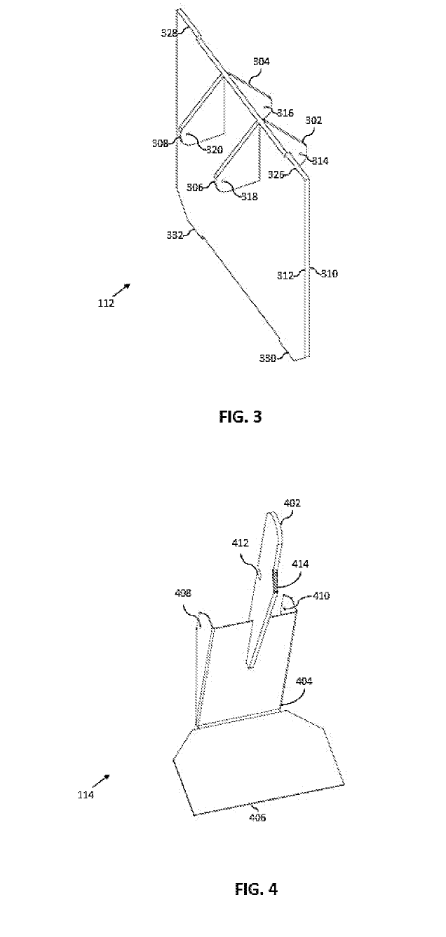

Referring now to FIG. 3 an isometric view of the central separation mount 112 of the rodent trap 100 according to an illustrative embodiment of the present invention is shown. The central separation mount 112 includes first through fourth extensions 302-308. Further, the central separation mount 112 includes a first face 310 and a second face 312, which is opposite to the first face 310. The first and second extensions 302 and 304 are placed adjacent to each other on the first face 310. Further, the third and fourth extensions 306 and 308 are placed adjacent to each other on the second face 312. The first through fourth extensions 302-308 include fifth through eighth holes 314-320, respectively. The first and second extensions 302 and 304 hold a first rod 322 by means of the fifth and sixth holes 314 and 316. The third and fourth extensions 306 and 308 hold a second rod 324 by means of the seventh and eighth holes 318 and 320. The central separation mount 112 further includes first through fourth tongues 326-332.

Referring now to FIG. 4 shows a front side view of the first trip lever 114 of the rodent trap 100 according to an illustrative embodiment of the present invention. The first trip lever 114 includes a first arm 402, a first fulcrum mount 404, and a first food tray 406. The first arm 402 is attached to the first fulcrum mount 404. The first fulcrum mount 404 is connected to the first food tray 406. The first fulcrum mount 404 includes ninth and tenth holes 408 and 410. The first arm 402 includes a first notch 412 and a first rough patch 414. The first arm 402 is made for example of either plastic (clear, opaque, or colored) or Plexiglas. Further, the first fulcrum mount 404 and the first food tray 406 may be made of any one of metal (aluminum, stainless steel, or galvanized steel), wood, plastic (clear, opaque, or colored), and Plexiglas. The first food tray 406 holds the bait such as cheese, nuts, and seeds for the rodents. The bait may also be a poison of some type allowing for the death of the rodent upon its eating the bait. The user of the trap can just dispose of the rodent after its death, and wash out the trap with soap and water, or merely a water hose.

Referring now to FIG. 5, an isometric view of the first trip lever 114 and a second trip lever 116 connected to the central separation mount 112 according to an illustrative embodiment of the present invention is shown. The second trip lever 116 is structurally and functionally similar to the first trip lever 114. The second trip lever 116 includes a second arm 502, a second fulcrum mount 504, a second food tray 506, a second notch 508, a second rough patch 510, and eleventh and twelfth holes 512 and 514. The fifth and sixth holes 314 and 316 of the first and second extensions 302 and 304 and the ninth and tenth holes 408 and 410 of the first fulcrum mount 404 are arranged in a manner such that the first rod 322 is passed through the fifth, ninth, tenth, and sixth holes 314, 408, 410, 316. The seventh and eighth holes 318 and 320 of the third and fourth extensions 306 and 308 and the eleventh and twelfth holes 512 and 514 of the first fulcrum mount 404 are arranged in a manner such that the second rod 324 is passed through the seventh, eleventh, twelfth, and eighth holes 318, 512, 514, 320. Thus, the first and second trip levers 114 and 116 are connected to the central separation mount 112 by way of the first and second rods 322 and 324, respectively.

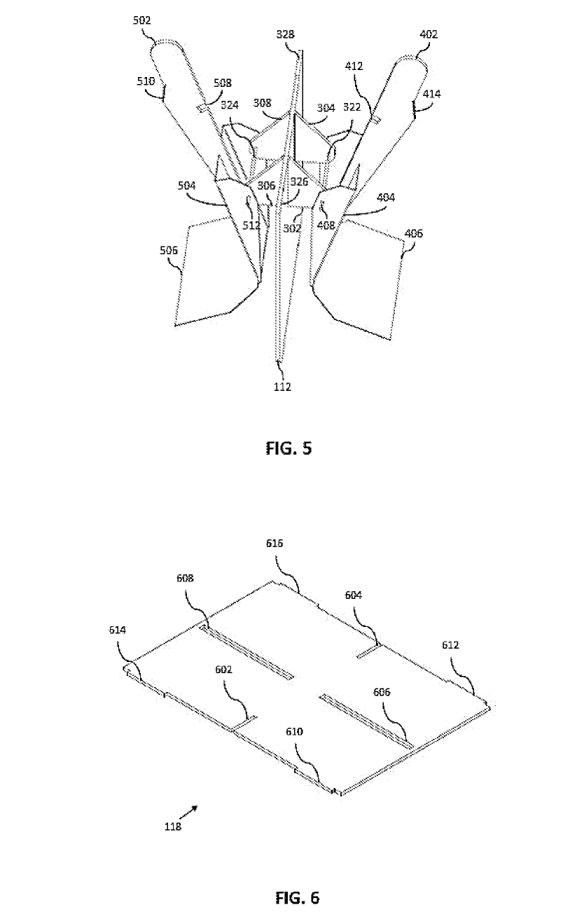

Referring now to FIG. 6 shows an isometric view of the top plate 118 of the rodent trap 100 according to an illustrative embodiment of the present invention. The top plate 118 includes first through fourth apertures 602-608 and fifth through eighth tongues 610-616.

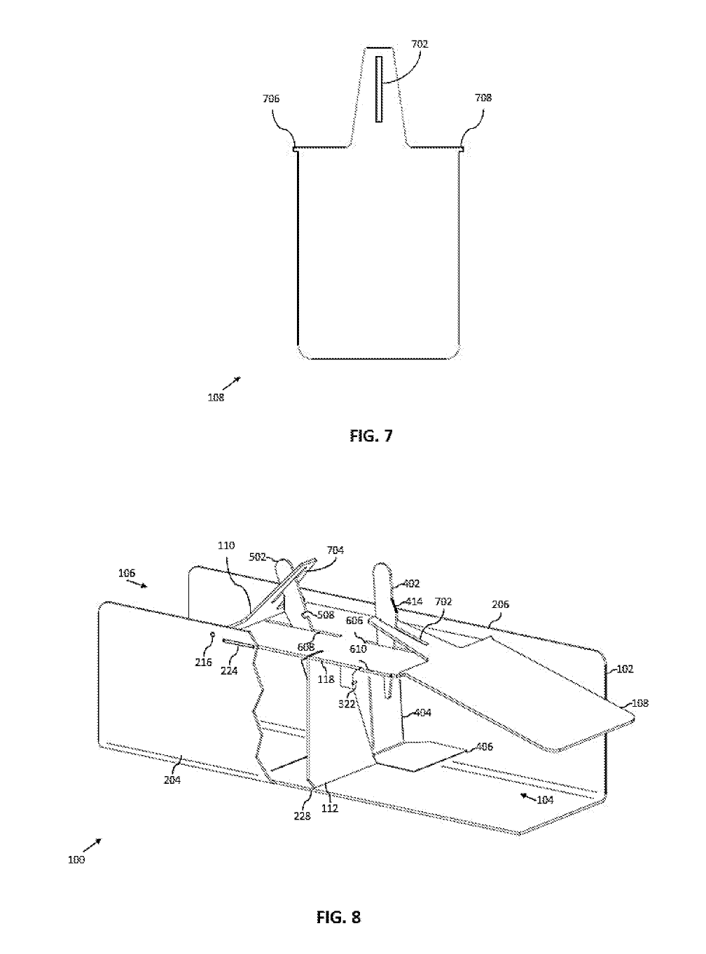

Referring now to FIG. 7 shows a front view of the first door member 108 of the rodent trap 100 according to an illustrative embodiment of the present invention. The second door member 110 is structurally and functionally similar to the first door member 108. The first door member 108 includes a fifth aperture 702 and the second door member 110 includes a sixth aperture 704. The first door member 108 is connected to the first trip lever 114 by way of the fifth aperture 702. The second door member 110 is connected to the second trip lever 116 by way of the sixth aperture 704. The first door member 108 further includes first and second projections 706 and 708. The second door member 110 further includes third and fourth projections 710 and 712.

Referring now to FIG. 8 a schematic sectional view of the rodent trap 100 assembly according to an illustrative embodiment of the present invention is shown. The fifth through eighth tongues 610-616 of the top plate 118 are fitted into the corresponding first through fourth slots 220-226 of the housing 102. Further, the first and second apertures 602 and 604 of the top plate 118 receive the first and second tongues 326 and 328 of the central separation mount 112, respectively. The third and fourth tongues 330 and 332 of the central separation mount 112 are fitted into the fifth and sixth slots 228 and 230 of the housing 102. Thus, the central separation mount 112 separates the housing 102 into first and second traps. The first and second projections 706 and 708 of the first door member 108 are fitted into the first and second holes 212 and 214 of the housing 102. The third and fourth projections 710 and 712 of the second door member 110 are fitted into the third and fourth holes 216 and 218 of the housing 102.

The first arm 402 of the first trip lever 114 is movably attached to the first door member 108 by way of the fifth aperture 702. The first arm 402 passes through the third aperture 606 of the top plate 118. The first trip lever 114 is attached to the first and second extensions 302 and 304 by way of the first rod 322 passing through the fifth and sixth holes 314 and 316. The first rod 322 provides support to the first fulcrum mount 404. The second arm 502 of the second trip lever 116 is movably attached to the second door member 110 by way of the sixth aperture 704. The second arm 502 passes through the fourth aperture 608 of the top plate 118. The second trip lever 116 is attached to the third and fourth extensions 306 and 308 by way of the second rod 324 passing through the seventh and eighth holes 318 and 320. The second rod 324 provides support to the second fulcrum mount 504.

When the rodent trap 100 is not in use, the first and second entrances 104 and 106 are open. The fifth aperture 702 of the first door member 108 is held by the first notch 412 and the sixth aperture 704 of the second door member 110 is held by the second notch 508. Further, the first and the second food trays 406 and 506 are upright. In FIG. 8 the first entrance 104 of the first trap is shown open for illustrative purpose.

To trap a rodent in the first trap, bait is placed on the first food tray 406. When the rodent enters the rodent trap 100 through the first entrance 104 to eat the bait, it places its weight on the first food tray 406. Thus, the weight of the rodent causes the first trip lever 114 to tilt about the first rod 322. The first arm 402 releases the first door member 108 from the first notch 412. Thus, the first door member 108 tilts about the first and second projections 706 and 708 in a manner such that the first entrance 104 gets closed. The fifth aperture 702 of the first door member 108 is then held by the first rough patch 414 of the first arm 402. This mechanism ensures that the rodent is unable to push the first door member 108 and stays trapped inside the first trap. Similarly, when the rodent is trapped in the second trap the sixth aperture 704 of the second door member 110 is then held by the second rough patch 510 of the second arm 502.

Thus, as the aforementioned rodent trap 100 uses lesser number of components as compared to the prior art rodent traps, it has a simple design. Thus, the components of the rodent trap 100 can be easily disassembled and reassembled. Further, it is easy to set-up the rodent trap 100 i.e. to place the bait in the food tray. Moreover, with a simple design of the rodent trap 100, two rodents can be trapped simultaneously in the first and second traps. As the aforementioned rodent trap 100 is made of either clear plastic or Plexiglas material, it is transparent and helps to easily identifying whether a rodent is caught in the rodent trap. Further, if the trapped rodent poops in the trap, the rodent trap 100 is unaffected by the fecal matter or other such excreta of the trapped rodent. Thus, the rodent trap 100 made of plastic (clear, opaque, or colored) does not get rusted due to the fecal matter of the rodent and is durable. Moreover, the bottom wall of the trap may include holes for easy cleaning of the rodent trap. Hence, the rodent trap 100 allows good sanitary conditions to be maintained. Further, the rodent trap 100 may be used as either a catch and release trap by releasing the trapped rodent to another location or a trap and kill by using a poisonous bait. As the rodent trap 100 can be used as a catch and release trap and does not mutilate the rodent, the rodent trap 100 is a more humane as compared to the rodent trap 100 described in the prior art. Further, the rodent trap 100 is reusable.

Alternate embodiments of the trap 100 include one or more parts of the rodent trap 100 combined together. This allows for fewer parts to attach, or possibly lose when the trap is not in use. As an exemplary implementation, the housing 102, the first and second entrances 104 and 106, the central separation mount 112 and the first and second trip levers 114 and 116 can be combined together to form a unit. Further, the first and second door members 108 and 110 can be removably mounted to the unit by means of the first through fourth holes 212-218 and the first through fourth projections 706-712 to form the assembly. Such an assembly reduces complexity and the time taken to set up the rodent trap 100.

Another embodiment of the rodent trap 100 includes the housing 102, the first entrance 104, the central separation mount 112, the first trip lever 114, and the first door member 108 form the assembly. Such an assembly forms a rodent trap 100 which can be set up in places with space constraints. The rodent trap 100 can further be made of different sizes to trap different rodent species. An exemplary but not limiting embodiment of the rodent trap 100 has, considering a length of the housing 102 as reference, a breadth and a height of the housing 102 as approximately 30% and 45%, and preferably about 31% and 43% of the length of the housing 102, respectively. Lengths and breadths of the first and second food trays 406 and 506 are about 10% and 20%, preferably about 19% of the length of the housing 102, respectively. Lengths of the first and the second trip levers 114 and 116 are about 25%30%, preferably about 26% of the length of the housing 102. The first and second notches 412 and 508 are placed at a distance of about 10% of the length of the housing 102 from the top of the first and second trip levers 114 and 116, respectively. Lengths of the first and second fulcrum mounts 404 and 504 are about 10% to about 15%, preferably about 12% of the length of the housing 102, and lengths and breadths of the first and second door members 108 and 110 are about 25% to about 40%, preferably about 38% and 26% of the length of the housing 102, respectively. Lengths of the third and fourth apertures 606 and 608 are approximately 10% of the length of the housing 102, a length and breadth of the top plate 118 is about 25% to 30%, preferably about 29% and 26% of the length of the housing 102, respectively, and length of the first and second rods 322 and 324 are about 30% to about 35%, preferably about 31% of the length of the housing 102, respectively.

Another exemplary but not limiting embodiment of the rodent trap 100 in accordance with the exemplary ratios can include the dimensions: the length, breadth, and height of the housing 102 are each approximately: 10½″, 3¼″, and 4½″, respectively, the length and breadth of the first and second food trays 406 and 506 are about 1″ and 2″, respectively, the length of first and second trip levers 114 and 116 are about 2¾″, the first and second notches 412 and 508 placed at a distance of about 1″ from the top of the first and second trip levers 114 and 116, respectively, the length of the first and second fulcrum mounts 404 and 504 are about 1¼″, the length and the breadth of the first and second door members 108 and 110 are about 4″ and 2¾″, respectively, the lengths of the third and fourth apertures 606 and 608 are about 1″, the length and breadth of the top plate 118 are about 3″ and 2¾″, respectively, and the length of the first and second rods 322 and 324 are about 3¼″. These dimensions are provided to allow one of skill in the art to reproduce the trap, but it is understood the dimensions can vary based on the desired size trap for the trapping of a particular sized rodent.

The present invention has been described herein with reference to a particular embodiment for a particular application. Although selected embodiments have been illustrated and described in detail, it may be understood that various substitutions and alterations are possible. Those having ordinary skill in the art and access to the present teachings may recognize additional various substitutions and alterations are also possible without departing from the spirit and scope of the present invention, and as defined by the following claim.

What is claimed is:

1. A rodent trap, comprising:
a housing having a bottom wall, a first side wall, and a second side wall, wherein the first side wall, the second side wall, and the bottom wall form first and second entrances, wherein the first and second side walls are perpendicularly mounted on the bottom wall, and wherein the first and second side walls are opposite to each other;
a central separation mount, including first through fourth extensions for providing support to first and second rods, is attached to the housing, wherein the central separation mount separates the housing into first and second traps;
a top plate, including first though fourth apertures, is attached to the central separation mount, wherein the top plate is attached to the central separation mount by way of the first and second apertures;
a first door member, having a fifth aperture, is attached to the housing to allow closure and opening of the first entrance;
a first trip lever having a first arm that is movably attached to the first door member by way of the fifth aperture, a first fulcrum mount, and a first food tray for holding a bait, wherein the first arm passes through the third aperture of the top plate, wherein the first rod provides support to the first fulcrum mount, and wherein a weight of a rodent on the first food tray causes the first trip lever to engage with the first door member such that the first door member closes the first entrance, whereby the rodent is trapped inside the first trap;
a second door member, having a sixth aperture, is attached to the housing to allow closure and opening of the second entrance; and
a second trip lever having a second arm that is movably attached to the second door member by way of the sixth aperture, and a second food tray for holding a bait, wherein the second arm passes through the fourth aperture of the top plate, wherein the second rod provides support to the second fulcrum mount, and wherein the weight of the rodent on the second food tray causes the second trip lever to engage with the second door member such that the second door member closes the second entrance, whereby the rodent is trapped inside the second trap.

2. The rodent trap of claim 1, wherein the first arm has a first notch and a first rough patch, wherein when the first entrance is open, the first door member is held by way of the first notch and when the first door member is closed, the first door member is held by the first rough patch.

3. The rodent trap of claim 2, wherein the weight of the rodent on the first food tray causes the first trip lever to engage, and wherein when the first trip lever is engaged, the first trip lever rotates about the first rod and releases the first door member, and wherein when the first door member is released, the first door member blocks the first entrance and the fifth aperture comes in contact with the first rough patch.

4. The rodent trap of claim 1, wherein the second arm has a second notch and a second rough patch, wherein when the second entrance is open, the second door member is held by way of the second notch and when the second door member is closed, the second door member is held by the second rough patch.

5. The rodent trap of claim 4, wherein the weight of the rodent on the second food tray causes the second trip lever to engage, and wherein when the second trip lever is engaged, the second trip lever rotates about the second rod and releases the second door member, and wherein when the second door member is released, the second door member blocks the second entrance and the sixth aperture comes in contact with the second rough patch.

6. The rodent trap of claim 1, wherein each of the housing, the central separation mount, the first and second arms, the first and second door members, and the top plate is made of at least one of plastic and Plexiglas.

7. The rodent trap of claim 1, wherein each of the first and second food trays, and the first and second fulcrum mounts is made of at least one of plastic, Plexiglas, glass, wood and metal.

8. A trip lever mechanism for use in a rodent trap assembly comprising:
a housing having a bottom wall, a first side wall, and a second side wall, wherein the first side wall, the second side wall, and the bottom wall form an entrance, wherein the first and second side walls are perpendicularly mounted on the bottom wall, and wherein the first and second side walls are opposite to each other;
a central separation mount, including a first and second extensions for providing support to a rod, is attached to the housing to form a trap;
a top plate, including first through third apertures, is attached to the central separation mount, wherein the top plate is attached to the central separation mount by way of the first and second apertures;
a door member, having a fourth aperture, is attached to the housing to allow closure and opening of the entrance;
a trip lever having an arm that is movably attached to the door member by way of the fourth aperture, a fulcrum mount, and a food tray for holding a bait, wherein the arm passes through the third aperture of the top plate, wherein the arm has a notch and a rough patch, wherein when the entrance is open, the door member is held by way of the notch and when the door member is closed, the door member is held by the rough patch, wherein the rod provides support to the fulcrum mount, wherein a weight of a rodent on the food tray causes the trip lever to engage, wherein when the trip lever is engaged the trip lever rotates about the rod and releases the door member, and wherein when the door member is released the door member blocks the entrance and the fourth aperture comes in contact with the rough patch, whereby the rodent is trapped inside the trap.
